(19) United States
(12) Patent Application Publication
(10) Pub. No.: US 2011/0207084 A1
(43) Pub. Date: Aug. 25, 2011

(54) METHOD AND APPARATUS FOR BONE DISTRACTION

(76) Inventor: Darnell Kaigler, SR., Detroit, MI (US)

(21) Appl. No.: 12/981,209

(22) Filed: Dec. 29, 2010

Related U.S. Application Data
(60) Provisional application No. 61/294,742, filed on Jan. 13, 2010.

(51) Int. Cl. A61C 8/00; A61C 13/225; A61C 5/11; A61C 13/23

(52) U.S. Cl. 433/174; 433/172; 433/219; 433/173

(57) ABSTRACT

The described embodiments relate to a transport prosthesis and a distraction device, which is surgically implanted against a bone, for the purpose of growing new bone through the process of distraction. The transport prosthesis is designed to be affixed to a patient's jaw to support the distraction device. The distraction device comprises a screw mechanism that attaches to a threaded post, which extends through tissue from an onlay plate that is surgically placed on the alveolar bone. After a brief, latent period, the screw mechanism is then activated daily until the desired amount of new bone growth is achieved.

This application claims priority to U.S. Provisional Patent Application No. 61/294,742, filed on Jan. 13, 2010, the entirety of which is incorporated herein by reference.

### FIELD OF THE INVENTION

Embodiments described herein relate generally to dental implant systems and methods for growing new bone, more particularly, to dental implant systems and methods for encouraging new bone growth in areas of the mouth that have suffered bone loss and most particularly to transport prostheses and distraction devices and methods for forming new bone growth and soft tissue by distraction osteogenesis in areas of the jaw bone.

### BACKGROUND

Orthopedic surgeons have conventionally relied upon the process of distraction osteogenesis to reconstruct and lengthen bones. This process may involve placing a vascularized piece of bone under tension, thereby inducing native bone formation via the creation of a bony reparative callus, which can then be placed under tension to generate new bone. To effect distraction osteogenesis, a surgeon generally performs an osteotomy where sectioning or segmenting the bone into more than one piece occurs. As the bone segments heal, they will gradually expand over a period of time; the gradual expansion allows the blood vessels and nerve ends to remain intact during the distraction process. For example, the bone may extend a millimeter a day, often by performing two extensions of half a millimeter, for three or four days which allow the blood vessels and nerve ends to remain intact.

As the gap between the bone segments widens, the natural healing capacity of the body can fill the void with new bone and adjacent soft tissue. Once the desired bone formation is achieved, the area may be allowed to heal and consolidate. Often, the distraction osteogenesis device is then removed.

Premature tooth loss may limit a patient's ability to chew and speak clearly. Tooth replacement is one solution to this problem. Conventionally, dentists have been able to replace missing teeth by various means. For example, a patient may be fitted with a removable prosthesis, such as partial or complete dentures. Another option is the placement of fixed bridge work cemented to adjacent teeth. While these conventional methods serve to fill the void of the edentulous space by replacing the crown of the involved teeth, they fail to cure other problems associated with premature tooth loss, such as bone deterioration.

Bone deterioration limits the surgical options available to dentists and may necessitate a dentist to place a smaller than optimal sized dental implant. These smaller dental implants often cannot accommodate the mechanical load from chewing, and ultimately may loosen and/or fail. Moreover, the bone deterioration may cause a dental implant to be placed in a location that is not as aesthetically or functionally optimal.

One prior solution to this bone deterioration problem, if the bone loss was not significant, was to augment the bony bed with the patient's own bone, cadaveric bone, or with synthetic bone substitutes. In cases where the bone loss is significant, the bone augmentation must be done as a first surgical procedure with the placement of the dental implant occurring several months later, as a second surgical procedure, once healing of the bone graft is completed.

There is a need for a new distraction device and method for allowing the rapid regeneration of new bone growth, reducing a patient's aesthetic concerns, reducing the need for bone grafts, and preventing the actual cutting of the bone in an area of bone deficiency.

### BRIEF SUMMARY

Various embodiments described herein relate to a transport prosthesis, which is temporarily installed in a patient's mouth, and supports a distraction device for promoting new bone growth through the process of distraction. In various embodiments, the transport prosthesis provides an aesthetically pleasing prosthesis that also allows a patient to chew, provides one or more drill guides for preparing a site for a permanent tooth implant, and/or provides a support, or transport, for a distraction device for regrowing bone.

Other embodiments described herein relate to a distraction device, which is surgically implanted, for promoting new bone growth through the process of distraction. A specific embodiment includes a device having an expansion component that attaches to a threaded post, which extends through tissue (transmucosa) from a plate, and is surgically placed on the alveolar bone. After a brief, latent period, the expansion component of the device is activated daily until the desired amount of new bone growth is achieved.

### BRIEF DESCRIPTION OF THE DRAWINGS

FIG. 1 is a top and back perspective view of a transport prosthesis in accordance with an embodiment described herein.

FIG. 2 is a top and side perspective view of the transport prosthesis shown in FIG. 1.

FIG. 3 is a bottom view of a portion of the transport prosthesis shown in FIG. 1.

FIG. 4 is a top and back perspective view of the transport prosthesis shown in FIG. 1.

FIG. 5 is a top view of covers to be used with the transport prosthesis shown in FIG. 1.

FIG. 6 illustrates a portion of a distraction device in accordance with an embodiment described herein.

FIG. 7 illustrates a distraction device and a portion of a transport prosthesis in accordance with an embodiment described herein.

FIG. 8 illustrates a distraction device and a portion of a transport prosthesis in accordance with another embodiment described herein.

FIG. 9 is a bottom and side perspective view of a portion of the transport prosthesis shown in FIG. 1 and a portion of a distraction device.

FIG. 10 is a front and bottom perspective view of a transport prosthesis in accordance with an embodiment described herein.

FIG. 11 is a bottom and side perspective view of the transport prosthesis shown in FIG. 10.

FIG. 12 is a front and bottom perspective view of the transport prosthesis shown in FIG. 10.

FIG. 13 is a front and bottom perspective view of a transport prosthesis in accordance with an embodiment described herein.

FIG. 14 is a front and bottom perspective view of the transport prosthesis shown in FIG. 13.

FIG. 15 is a front and bottom perspective view of a transport prosthesis in accordance with an embodiment described herein.

FIG. 16 is a front and bottom perspective view of the transport prosthesis shown in FIG. 15.

FIGS. 17-26 illustrate steps in a method of implanting a transport prosthesis in accordance with an embodiment described herein.

FIG. 27 is a perspective view of a transport prosthesis according to another embodiment described herein.

FIG. 28A is a perspective view, FIG. 28B is a top view, and FIG. 28C is a cut-away perspective view of a transport ring.

FIG. 29 is a side view of the transport prosthesis of FIG. 27.

FIG. 30 is a perspective view of a saddle and sheath housing.

### DETAILED DESCRIPTION

Embodiments discussed herein provide techniques and apparatuses for promoting new bone growth and soft tissue by distraction osteogenesis in areas of the jaw bone and/or maxillofacial region. In the following description, numerous specific details are set forth, such as material types, dimensions, specific tissues, etc., in order to provide a thorough understanding of embodiments of the invention. Practitioners having ordinary skill in the biomedical arts will understand that embodiments of the invention may be practiced without many of these details. In other instances, well-known devices, methods, and biochemical processes have not been described in detail to avoid obscuring the invention.

Embodiments discussed herein offer solutions to the foregoing problems by providing a transport prosthesis and distraction device that can regenerate new bone growth, reduce a patient's aesthetic concerns, protect a patient's biting surface, prevent multiple surgical procedures, enhance the structural integrity, and reduce bone deterioration of existing bone. The transport prosthesis and distraction device may be provided to dental practitioners as a complete, customized system for regenerating bone and soft tissue on a controlled vector thereby allowing for ideal aesthetic and prosthetic rehabilitation through optimal implant placement. The transport prosthesis and distraction device provides practitioners the capability to restore a patent from partial or complete edentulism without the need for bone harvesting from a donor site and without the need for a through and through osteotomy.

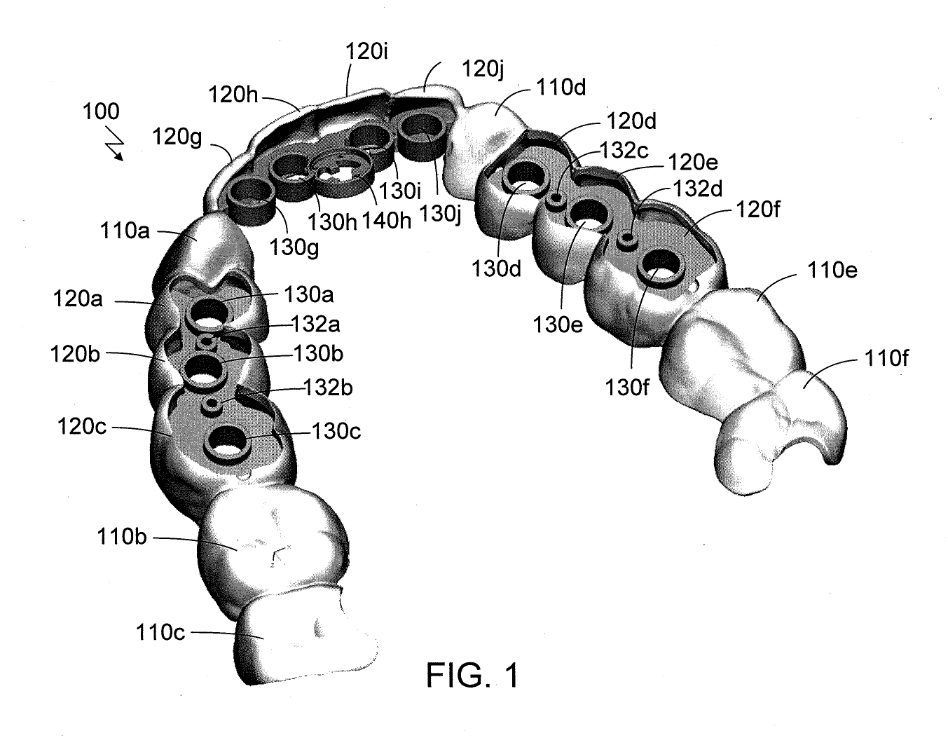

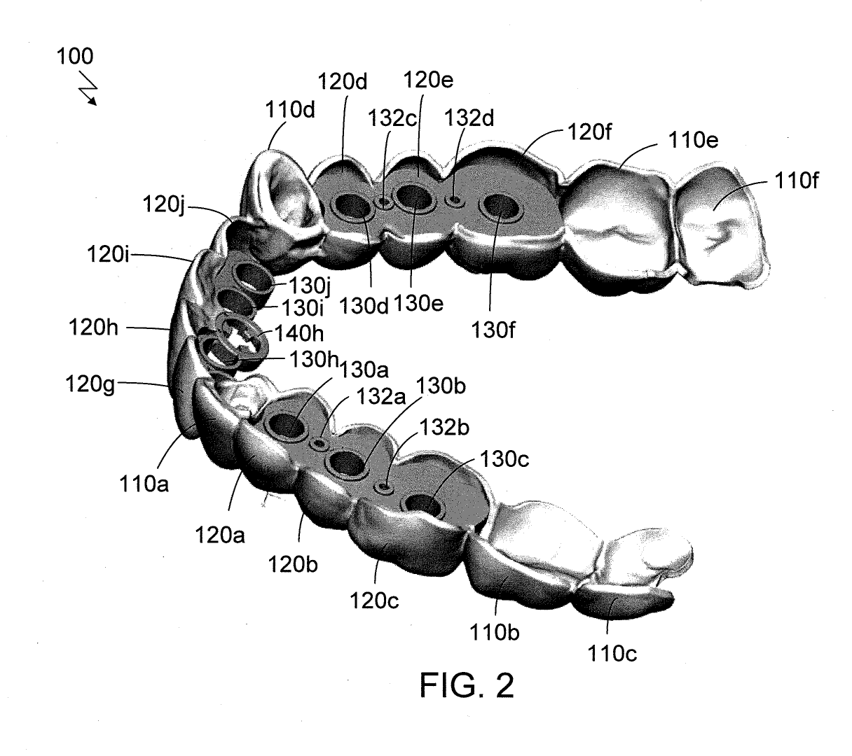

FIG. 1 shows a top and back perspective view of a transport prosthesis 100 that is designed to be affixed to a patent's remaining teeth or jaw bone of the lower jaw, where the patient is in need of new bone growth on the jaw bone or within the maxillofacial region and/or one or more tooth implants. FIG. 2 shows a top and side perspective view of the transport prosthesis 100.

The transport prosthesis 100 includes a number of prosthetic guide teeth 120a-j. One or more, or all, of the guide teeth 120 may include a main aperture 130a-j arranged therein to allow access from the top of the prosthetic tooth to the bottom of the prosthetic tooth. The main aperture 130 may be used to provide access to the jaw bone such that a hole can be drilled and used to implant an implant fixture device or permanent prosthetic device, for example, a root of a permanent prosthetic tooth. As shown in FIG. 1, where a guide tooth 120a-f is wide enough, the main aperture 130a-f may be arranged through the guide tooth itself. Otherwise, where the guide tooth 120g-j is shaped as a veneer and is therefore too narrow to accommodate a main aperture, the main aperture 130g-j may be formed by a structure, e.g., a hoop, attached to and arranged behind the guide tooth. Although the embodiment shown in FIG. 1 shows the main aperture 130g-j structure formed as a round hoop, it should be appreciated that other shapes could also be used, such as square, triangular, and other regular or irregular polyhedrons.

The guide teeth 120 may also include one or more pairs of guide holes 132a and 132b, 132c and 132d which may be used to precisely locate a drill above the desired main aperture 130b or 130e, respectively. For example, a drill (not shown), may include one or more protrusions that may be fit into the guide holes 132a and 132b to position the drill over the main aperture 130b. The drill may then be used to drill into the bone underneath to create a hole for a permanent prosthetic while its position is maintained by the interlocking of the protrusions and the guide holes 132. In the embodiment shown in FIG. 1, guide holes 132a-d are only provided for guide teeth 120b and 120e. In other embodiments, guide holes 132 may be provided for only one guide tooth, more than one guide teeth, or all guide teeth.

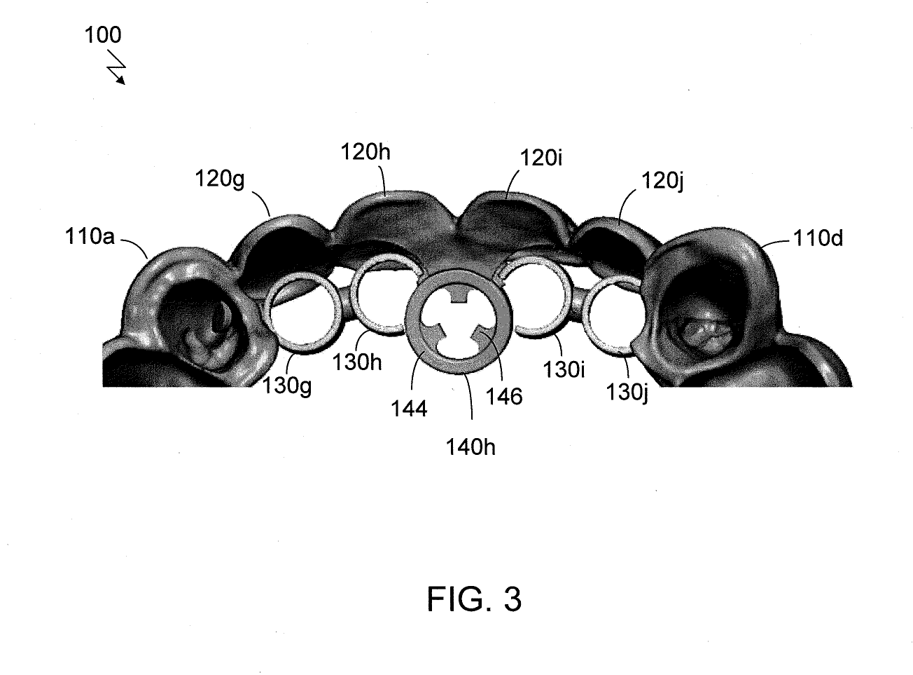

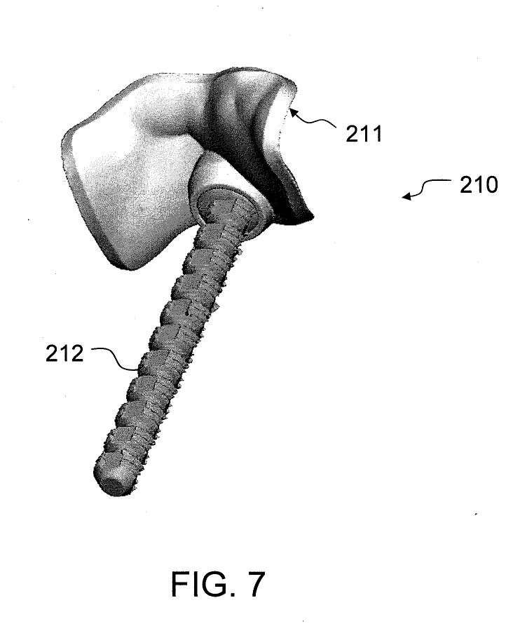

One or more of the guide teeth 120 may also have attached to them a device support 140. FIG. 3 shows a bottom view of device support 140h arranged on the transport prosthesis of FIG. 1. Device support 140h is used to support a distraction device 200 (FIG. 7). As will be described in further detail below, an expansion component may be used to incrementally move a plate component of the distraction device. The device support 140h includes a ring 144 and optionally a number of protrusions 146 for supporting the expansion component 220. While device support 140h shown in FIGS. 1, 2, and 3 is depicted as a ring, it should be understood that the device support 140h could be formed in other shapes, such as square, triangular, and other regular or irregular polyhedrons. In the embodiment shown in FIGS. 1 and 2, one device support 140h is used to support a distraction device that will be used to promote bone growth for the area under four different prosthetic teeth 120g-j. In other embodiments, a device support 140h may be provided for a single tooth, two teeth, three teeth, five teeth, or more.

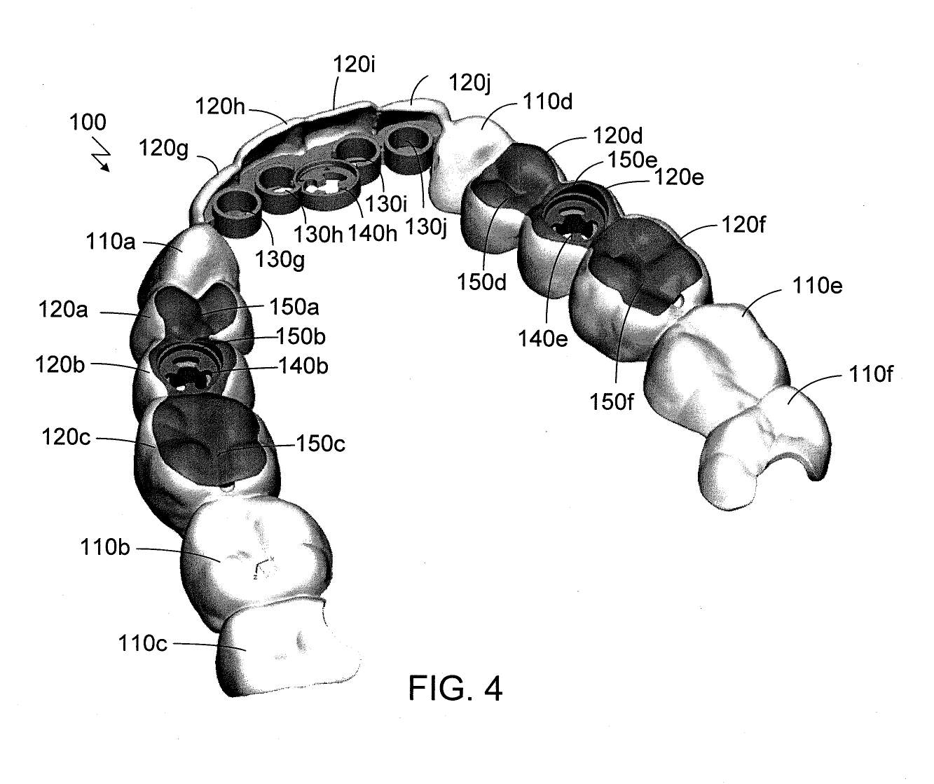

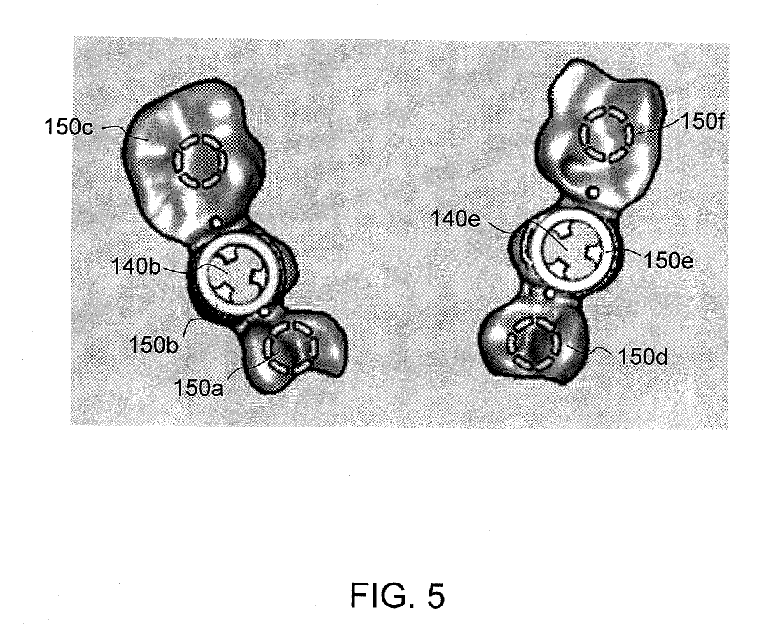

FIG. 4 shows the transport prosthesis 100 of FIG. 1 further including a number of covers 150a-f arranged on the prosthetic teeth 120a-f. Covers 150a-f, also shown in FIG. 5, are used to cap the guide teeth 120a-f and cover the main apertures 130a-f until they are needed. As shown in FIG. 4, covers 150a-f may be shaped as an uppermost portion of a tooth and may fit over the prosthetic teeth 130a-f to complete the top portion of a tooth shape. In one embodiment, covers 150a-f may attach to the prosthetic teeth 130a-f by snapping on and may be removed by snapping off or prying off. In another embodiment, covers 150a-f may be cemented into place. A number of the covers 150b, 150e may have a device support 140b, 140e, respectively, arranged in the covers to support a distraction device. The device support 140b, 140e includes a through hole to allow a distraction device 200 to be arranged through the prosthetic teeth 120b, 120e. Although the embodiment in FIG. 4 shows only two caps having device supports, it should be understood that a lesser or greater number of caps could be provided with device supports.

In one embodiment, where the patient is partially edentulous, the transport prosthesis 100 includes a number of caps 110a, 110b, 110c, 110d, 110e, 110f, which are hollow teeth that may be shaped to conform to and fit over top of a patient's remaining teeth. It should be understood that the placement and shape of the caps 110 may be modified as needed to fit a patient's remaining teeth. Alternatively, if a patient is missing a tooth, but does not require bone growth or a prosthetic implant in the region of the missing tooth, the cap 110 overlying that area may be formed as a solid prosthetic tooth. In another embodiment, where the patient is completely edentulous, the caps may be omitted completely and all of the prosthetic teeth may be formed as drill guides.

While the transport prosthesis 100 in the embodiment of FIG. 1 is a full arch, it should be understood and appreciated that in other embodiments, the transport prosthesis may be formed as a partial arch. In another embodiment, the transport prosthesis could be in the form of a dental bridge, e.g., a resin-bonded bridge or Maryland bridge, and may be cemented into place in the gap between two remaining teeth. The application of a transport prosthesis in the form of a Maryland bridge enables a dentist to install the transport prosthesis with a minimum amount of tooth modification by cementing the transport prosthesis to acid etched enamel and an acid etched cast metal framework. The patient's abutment teeth may be left basically intact and undamaged.

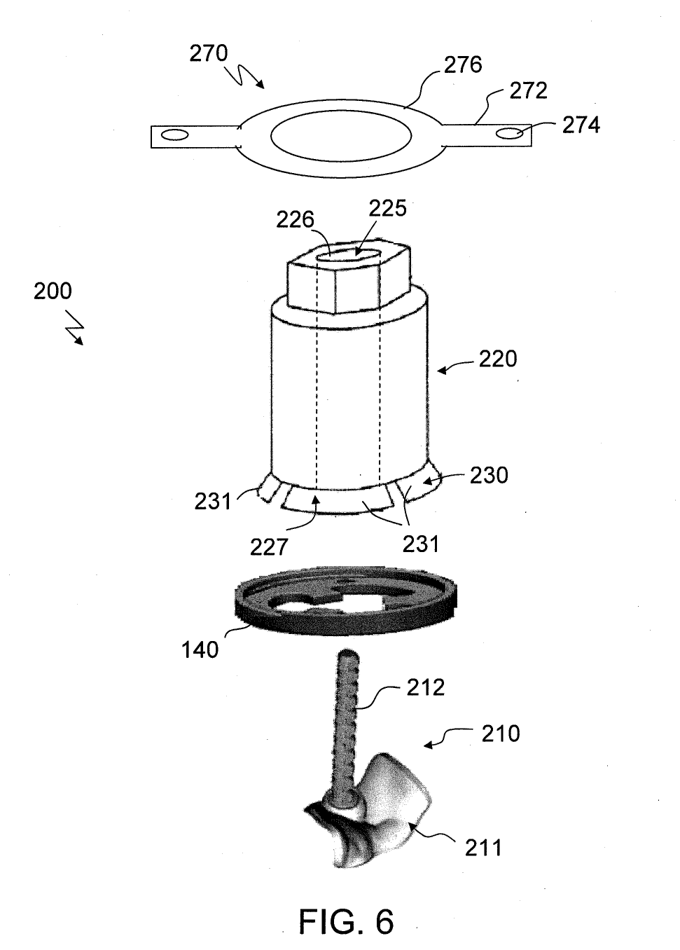

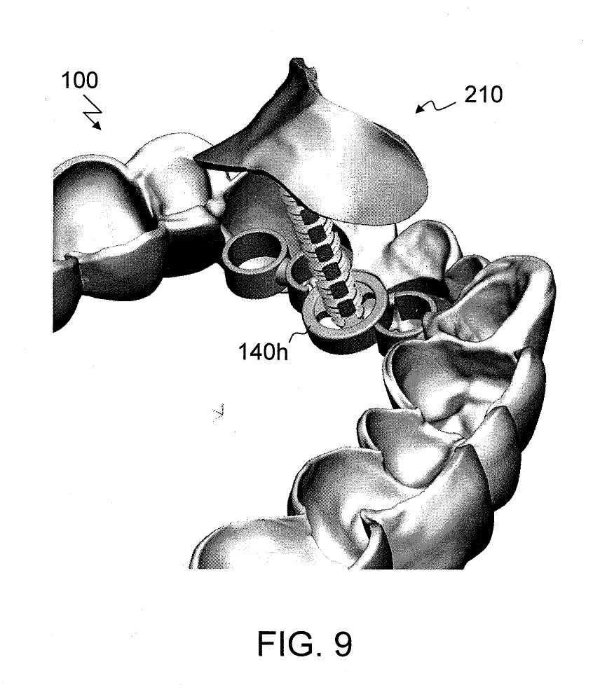

A bone distraction device 200 that may be mounted to the device support 140 is shown in FIG. 6 and is further described in U.S. patent application Ser. Nos. 12/394,480 and 12/619,563, the disclosures of which are hereby incorporated by reference in their entirety. The bone distraction device 200 comprises a plate component 210 and an expansion component 220. The plate component 210 has a plate 211 and a stem 212 (or apical portion) extending vertically from the plate 211. In various embodiments, the stem 212 may be a threaded cylinder. The expansion component 220 (coronal portion) operatively connects and controls the retraction of the plate component 210. FIG. 9 shows a view of the bottom of a portion of the transport prosthetic 100 in which the plate component 110 has been inserted into the device support 140h.

The expansion component 210 may be retained in contact with the device support 140 by use of a washer 270. The washer 270 may include an annular portion 276 and a number of retaining portions 272. In use, the annular portion 276 may be arranged over and in contact with the expansion component 210 in such a way that the expansion component 210 may still rotate. The retaining portions 272 may be attached to the device support 140 by, for example, welding, adhesive, press fitting, melting, or other attachment methods. In one embodiment, the washer 270 may include two retaining portions 272. In another embodiment, the retaining portions 272 may include a holes 274 that may match up with protrusions on the device support 140 to better hold the washer 270 in place.

The plate component 210 and expansion component 220 can independently be formed of a material selected from one or more of the following materials: commercially pure titanium, titanium alloys, other metal alloys, or other metal substances. It should be noted that the metal substance should meet or exceed the parameters for materials used in dental implantology. It should be also appreciated that the plate and expansion components 210, 220 can be formed of a degradable or non-degradable bioceramic material, e.g., hydroxyapatite, reinforced polyethylene composite, betatricalciumphosphate, substituted calcium phosphates, bioactive glass, resorbable calcium phosphate, alumina, zirconia, etc. that may be manufactured as a solid structure. It should also be noted that a biodegradable polymer can be used in combination with the bioceramic material to form a composite material used to form the plate and expansion components 210, 220. In the preferred embodiment, a hydroxyapatite material is utilized to form the plate and expansion components 210, 220. The plate and expansion components 210, 220 can be formed by any type of material known in the art having characteristics that result in non-toxic byproducts.

For example, plate and expansion components 210, 220 can be formed of synthetic polymers (alone or in combination) such as polyurethanes, polyorthoesters, polyvinyl alcohol, polyamides, polycarbonates, poly(ethylene)glycol, polylactic acid, polyglycolic acid, polycaprolactone, polyvinyl pyrrolidone, marine adhesive proteins, trimethylene carbonate, L-lactide, D,L-lactide, polyglycolide, and cyanoacrylates, or analogs, mixtures, combinations, and derivatives of the above. Plate and expansion components 210, 220 can also be formed of naturally occurring polymers or natively derived polymers (alone or in combination) such as agarose, alginate, fibrin, fibrinogen, fibronectin, collagen, gelatin, hyaluronic acid, and other suitable polymers and biopolymers, or analogs, mixtures, combinations, and derivatives of the above. Also, plate and expansion components 210, 220 can be formed from a mixture of naturally occurring biopolymers and synthetic polymers. Alternatively, plate and expansion components 210, 220 can be formed of a collagen gel, a polyvinyl alcohol sponge, a poly(D,L-lactide-co-glycolide) fiber matrix, a polyglactin fiber, a calcium alginate gel, a polyglycolic acid mesh, polyester (e.g., poly-(L-lactic acid) or a polyanhydride), a polysaccharide (e.g., alginate), polyphosphazene, or polyacrylate, or a polyethylene oxide-polypropylene glycol block copolymer. Plate and expansion components 210, 220 can be produced from proteins (e.g. extracellular matrix proteins such as fibrin, collagen, and fibronectin), polymers (e.g., polyvinylpyrrolidone), or hyaluronic acid. Synthetic polymers can also be used, including bioerodible polymers (e.g., poly(lactide), poly(glycolic acid), poly(lactide-co-glycolide), poly(caprolactone), polycarbonates, polyamides, polyanhydrides, polyamino acids, polyortho esters, polyacetals, polycyanoacrylates), degradable polyurethanes, non-erodible polymers (e.g., polyacrylates, ethylene-vinyl acetate polymers and other acyl substituted cellulose acetates and derivatives thereof), non-erodible polyurethanes, polystyrenes, polyvinyl chloride, polyvinyl fluoride, poly(vinylimidazole), chlorosulphonated polyolifins, polyethylene oxide, polyvinyl alcohol, Teflon®, and nylon.

Bioceramic materials employed as the manufacturing material can fall into all three biomaterial classifications, i.e., inert, resorbable and active, meaning they can either remain unchanged, dissolve or actively take part in physiological processes. There are several calcium phosphate ceramics that are considered biocompatible and possible materials for the plate component 210. Of these, most are resorbable and will dissolve when exposed to physiological environments, e.g., the extracellular matrix. Some of these materials include, in order of solubility: Tetracalcium Phosphate (Ca₄P₂O₉)>Amorphous calcium Phosphate>alpha-Tricalcium Phosphate (Ca₃(PO₄)₂)>beta-Tricalcium Phosphate (Ca₃(PO₄)2)>>Hydroxyapatite (Ca₁₀(PO₄)₆(OH)₂). Unlike the other certain calcium phosphates listed above, hydroxyapatite does not break down under physiological conditions. In fact, it is thermodynamically stable at physiological pH and actively takes part in bone bonding, forming strong chemical bonds with surrounding bone. This property is advantageous for rapid bone repair after surgery. Other bioceramic materials such as Alumina and Zirconia are known for their general chemical inertness and hardness. These properties can be exploited for implant device support purposes, where it is used as an articulating surface for implant devices. Porous alumina can also be used as a bone spacer, where sections of bone have had to be removed due to various conditions or diseases. The material acts as an environment that promotes bone growth.

At times, biodegradable polymers suffer from warping, hollowing or substantial erosion inherent with the process of degradation. In order to manage such a problem, polymers with high crystallinity are utilized. Self-reinforced and ultrahigh strength bioabsorbable composites are readily assembled from partially crystalline bioabsorbable polymers, like polyglycolides, polylactides and glycolide/lactide copolymers. These materials have high initial strength, appropriate modulus and strength retention time from 4 weeks up to 1 year in-vivo, depending on the implant geometry. Reinforcing elements such as fibers of crystalline polymers, fibers of carbon in polymeric resins, and particulate fillers, e.g., hydroxyapatite, may also be used to improve the dimensional stability and mechanical properties of biodegradable devices. The use of interpenetrating networks (IPN) in biodegradable material construction has been demonstrated as a means to improve mechanical strength. To further improve the mechanical properties of IPN-reinforced biodegradable materials, biodegradable plates may be prepared as semi-interpenetrating networks (SIPN) of crosslinked polypropylene fumarate within a host matrix of poly(lactide-co-glycolide) 85:15 (PLGA) or poly(1-lactide-co-d,l-lactide) 70:30 (PLA) using different crosslinking agents.

Resin composites with incorporated polytetrafluoroethylene (PTFE) particles improve the hydrophobicity and surface properties of device implants, e.g., components 210, 220. PTFE has high resistance to chemical regents, low surface energy, tolerance to low and high temperatures, resistance to weathering, low friction wiring, electrical insulation, and slipperiness. However, because conventional PTFE has poor resistance to abrasion, the inventor contemplates cross-linking PTFE with gamma-beam irradiation to drastically enhance resistance to abrasion and deformation. Further, the composites made of braided carbon fibers and epoxy resins (so called biocompatible carbon-epoxy resin) have better mechanical properties than composites made of short or laminated unidirectional fibers.

FIG. 7 shows the plate component 210 and stem 212 of the distraction device 200 of FIG. 6. The stem 212 may be solid or may be hollow. If the stem 212 is hollow, fluids such as medicine or cells may be injected through the stem 212 to the patient's bone. The plate 211 of the plate component may be formed of a biocompatible and bioresorbable polymer as described in U.S. Pat. No. 6,607,548, the disclosure of which is hereby incorporated by reference in its entirety. The plate 211 may be solid or perforated. The polymer may be a melt-blended polymer composition including a base material including a biodegradable polymer or copolymer, and a copolymer additive including one or more monomers imparting a tensile strength for the implant at room temperature that is lower than a tensile strength at room temperature for an implant formed from the base material excluding the copolymer additive. In another embodiment, the polymer may be a melt-blended polymer composition including a base material including a biodegradable polymer or copolymer, and a copolymer additive including one or more monomers imparting a tensile strength for the melt-blended polymer composition at room temperature that is lower than a tensile strength at room temperature for the base material.

To form the polymer, a biodegradable polymer or copolymer is provided as an initial base material and is then combined with one or more copolymer additives to alter the tensile properties of the biodegradable polymer or copolymer. The base material of the biodegradable polymer may be a polymer or copolymer of lactic acid, L-lactide, D-lactide, D,L-lactide, meso-lactide, glycolic acid, glycolide and the like and optionally other cyclic esters which are copolymerizable with lactide. Additional co-monomers may also be present to impart desired properties as needed such as alpha-, beta- or gamma-hydroxybutyric acid, alpha-, beta- or gamma-hydroxyvaleric acid and other hydroxy fatty acids (C₁₁ to C₂₅) such as stearic acid, palmitic acid, oleic acid, lauric acid and the like. Accordingly, the base material may include polylactides, polyglycolides, poly(L-lactide), poly (D-lactide), poly(L-lactide-co-D,L-lactide), poly(L-lactide-co-meso-lactide), poly(L-lactide-co-glycolide), poly(L-lactide-co-epsilon-caprolactone), poly(D,L-lactide-co-meso-lactide), poly(D,L-lactide-co-glycolide), poly(D,L-lactide-co-epsilon-caprolactone), poly(meso-lactide-co-glycolide), poly(meso-lactide-co-epsilon-caprolactone) and the like. When the base material is a copolymer, the monomer units may be present in a ratio of 50:50, 60:40, 70:30, 80:20, 85:15 and all suitable ratios in between. For example, suitable base materials include poly(L-lactide-co-D,L-lactide) 70:30, poly(L-lactide-co-D,L-lactide) 80:20, poly(L-lactide-co-glycolide) 85:15, and poly(L-lactide-co-glycolide) 80:20. Copolymers that contain L-lactide as a component preferably contain at least 70% of the L-lactide component and more preferably between about 70% and about 95% of the L-lactide component. Polymers or copolymers useful as base materials are commercially available from many sources or can be readily manufactured using methods well-known to those skilled in the art.

The plate 211 may be formed by processing steps including injection molding, extrusion, pressure melting, hot pressing and other like methods known to those skilled in the art. In one embodiment, the polymer may be available to a dentist as a sheet of material. To form the plate 211, the dentist may cut off an appropriate amount of the polymer from the sheet and bend and shape the polymer to conform to a patient's jaw bone. In various embodiments, the plate may be conformed to the patient's jaw bone as exactly as possible, or more generally, by creating a general shape thereof. In one embodiment, the polymer material may be softened by submerging the polymer in water, and then once malleable, the polymer material can be shaped, connected to the stem 212, and allowed to harden. In another embodiment, the polymer material may be provided to the dentist in predetermined sizes and/or may include preformed holes for attaching the threaded cylinder portion 212.

The outer surface of both the plate and expansion components 210, 220 can be covered/roughened with a surface coating, for example, chitosan, for additional bone growth. The plate and expansion components 210, 220 having corresponding cylinder like portions (threaded cylinder portion 212 and hollow slot 225 (described below)), can be conventionally threaded (externally on the plate component 210 and internally on the expansion component 220) with clockwise or counterclockwise treads. The threads of the plate component 210 start about two (2) mm (for example) from the base of the plate component 210 and continue vertically along the entire length of the cylinder 212 of the plate component 210. The threaded cylinder portion 212 may be rigidly attached to the plate component 211 by the use of threads or may be movably fitted to the plate component 211 by the use of a chamfered portion.

As shown in FIG. 6, the expansion component 220 has a hollow slot 225 extending completely through, and within the full length, of the expansion component (completely from the top end 226 to the bottom end 227 of the expansion component 220) having threads. The hollow slot 225 has a cylindrical configuration and comprises internal clockwise or counterclockwise threads that correspond to respective threads on the cylinder 212 of the plate component 210. The pitch of the threads on the plate and expansion components 210, 220 can be any pitch that promotes new bone growth of approximately 0.5 mm/day. Examples of a pitch that promotes new bone growth include, for example, 0.25 mm, 0.3 mm, 0.5 mm, 1.0 mm, 1.5 mm and 2.0 mm. The length of the expansion component 220 may vary depending on the required distraction; an example includes a length of the expansion component 220 of approximately 3.5 mm.

In order to enable the surgeon or patient to easily read the distance of distraction after having activated the distraction expansion component 220 (as described below), the head of the expansion component 220 is preferably marked on the surface between the center and the side of the expansion component 220. The mark may be an indentation in the expansion component 220 and/or may consist of a different color.

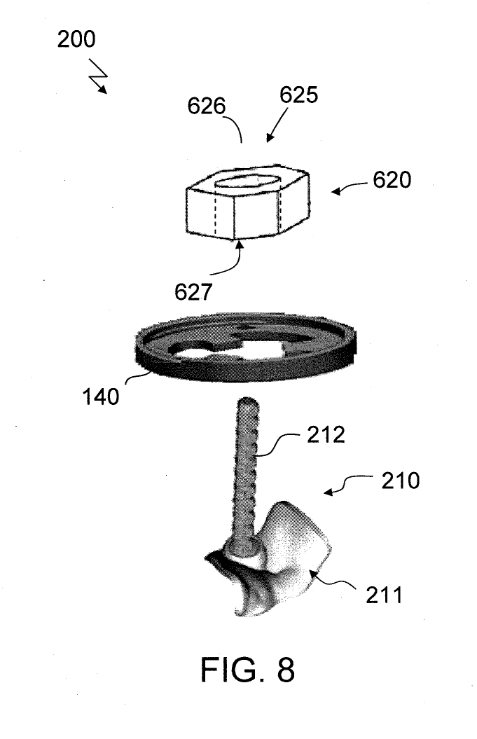

The expansion component 220 may include interlacing or interlocking complimentary locking members 231 on the surface facing the device support 140 to interlock with the protrusions 146 of the device support 140 and prevent rotation of expansion component 220 during the transportation process. As described below, the expansion component 220 of the distraction device 200 provides for retraction between the plate and expansion components 210, 220 to form a distraction gap, between the plate component 210 and the patient's bone. In the embodiment shown in FIG. 8, the expansion component 220 may be replaced with a threaded nut 620 having a bottom end 627, a top end 626, and a hollow slot 625.

In one embodiment, the expansion component may be driven by the use of pneumatic or hydraulic pressure. For example, in order to operate the expansion component, a pneumatic or hydraulic source may be attached to the expansion component to adjust the expansion component with greater precision than might otherwise be obtained by hand. In another embodiment, a pneumatic or hydraulic source might be arranged to increase pressure under the plate component thus raising the plate component and the expansion component serving to hold the plate component in place after it is raised.

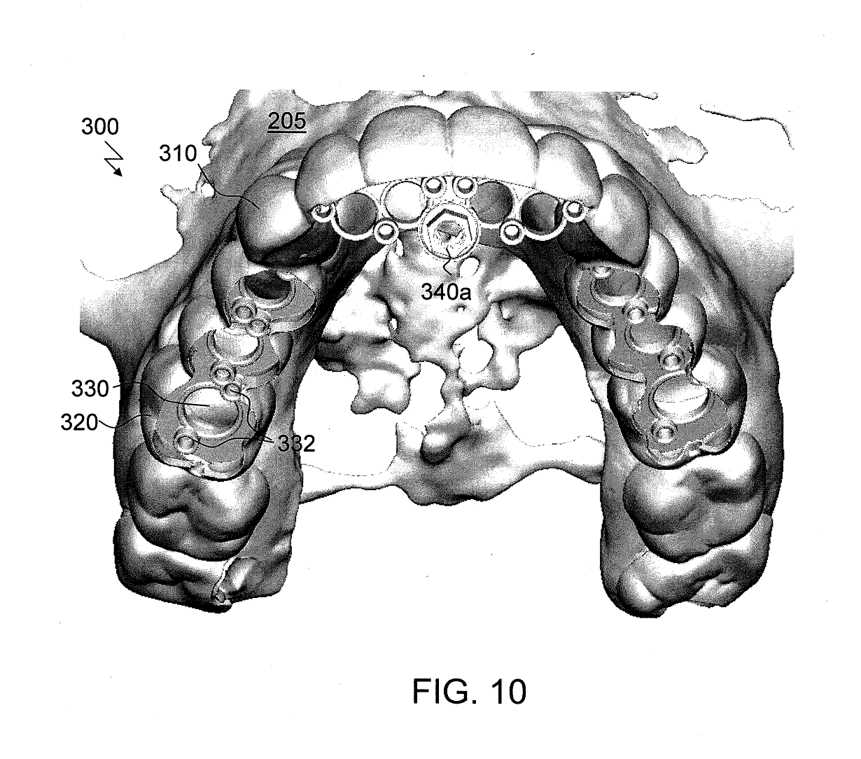

FIG. 10 shows a transport prosthesis 600 affixed to a patent's remaining teeth and jaw bone 205 of the upper jaw, where the patient is in need of bone growth on the jaw bone or maxillofacial region and/or one or more tooth implants. Similar to the embodiment shown in FIG. 1, the transport prosthesis 300 includes a number of prosthetic guide teeth 320, which may include a main aperture 330 arranged either within or behind the guide tooth. The main aperture 330 may be used to provide access to the jaw bone to drill a hole that will be used to implant an implant fixture device or permanent prosthetic device, for example, a root of a permanent prosthetic tooth. The transport prosthesis also includes a device support 340a for supporting a distraction device.

In the embodiment shown in FIG. 10, each guide tooth 320 is provided with a pair of guide holes 332 which may be used to precisely locate a drill above the desired main aperture. A drill (not shown) that includes two protrusions may be fit into the guide holes 332 to position the drill over the main aperture 330. The drill may then be used to drill into the bone underneath to create a hole for an implant fixture device or permanent prosthetic device, for example, a root of a permanent prosthetic tooth, while its position is maintained by the interlocking of the protrusions and the guide holes 332. Where the guide tooth is a veneer too small to include a guide hole through the guide tooth, the guide holes may be formed as smaller hoops connected to the guide hoops.

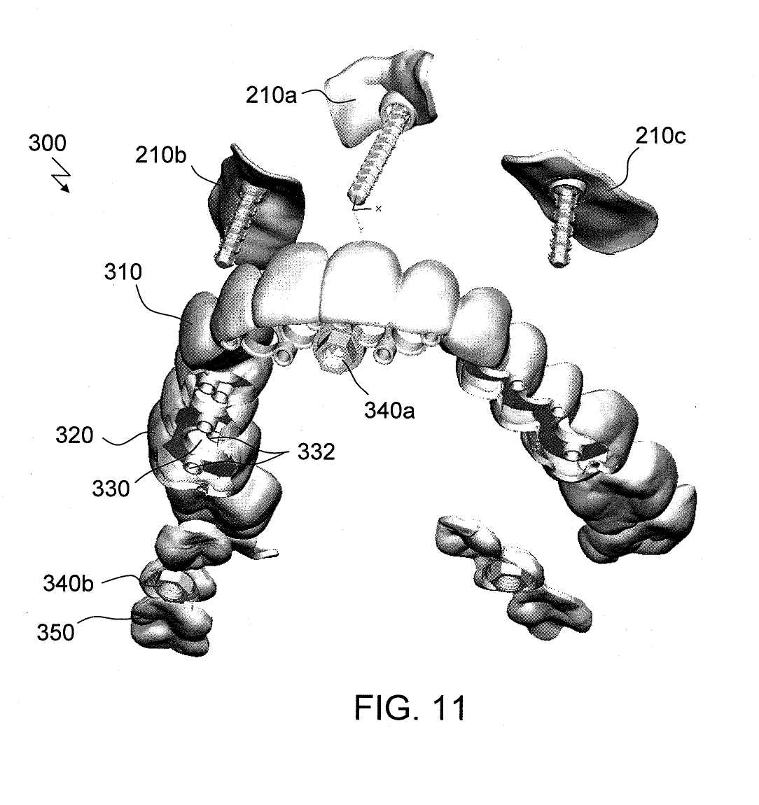

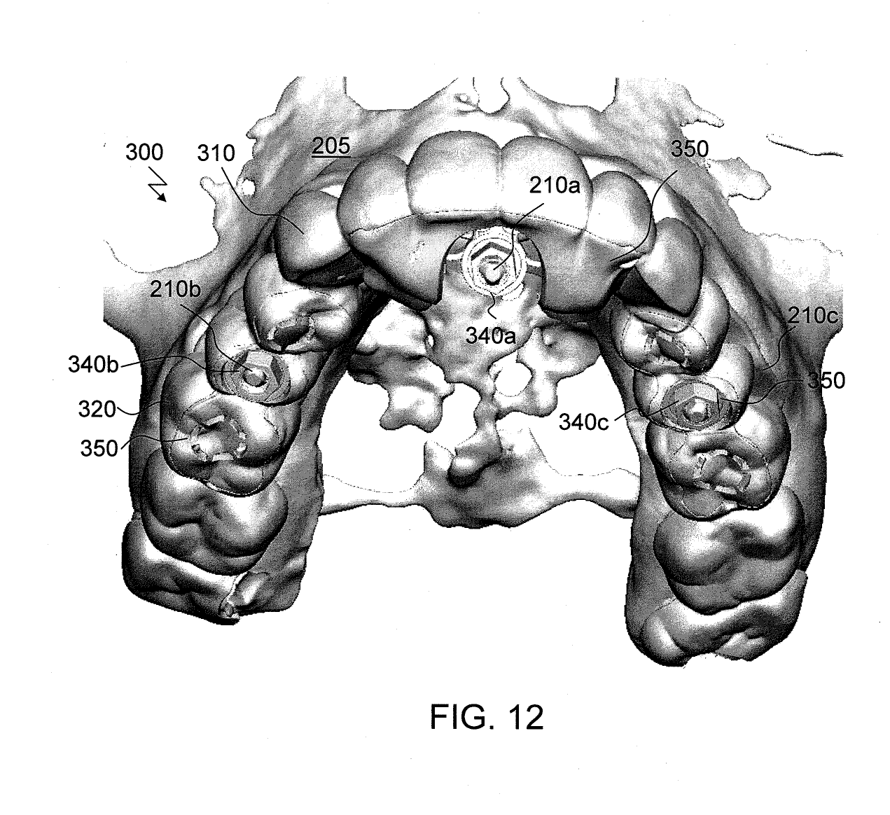

FIG. 11 shows a front and bottom perspective view of the prosthesis of FIG. 10 and also shows an exploded view of the accompanying caps 350 and plate components 210a-c. FIG. 12 shows the transport prosthesis 300 of FIG. 10 affixed to a jaw bone 205 and having the covers 350 arranged on the guide teeth 320. The covers 350 are used to cap the guide teeth 320 and cover the main apertures 330 until they are needed. Similar to the covers 150 of the embodiment of FIG. 4, the covers 350 shown in FIG. 12 may be contoured to fit over and complete the top portions of the prosthetic teeth 530 and the covers 350 may attach to the prosthetic teeth 330 by snapping or cementing on and may be removed by snapping off or prying off. The transport prosthesis of FIG. 12 includes three separate device supports 340a-c to support the three plate components 210a-c.

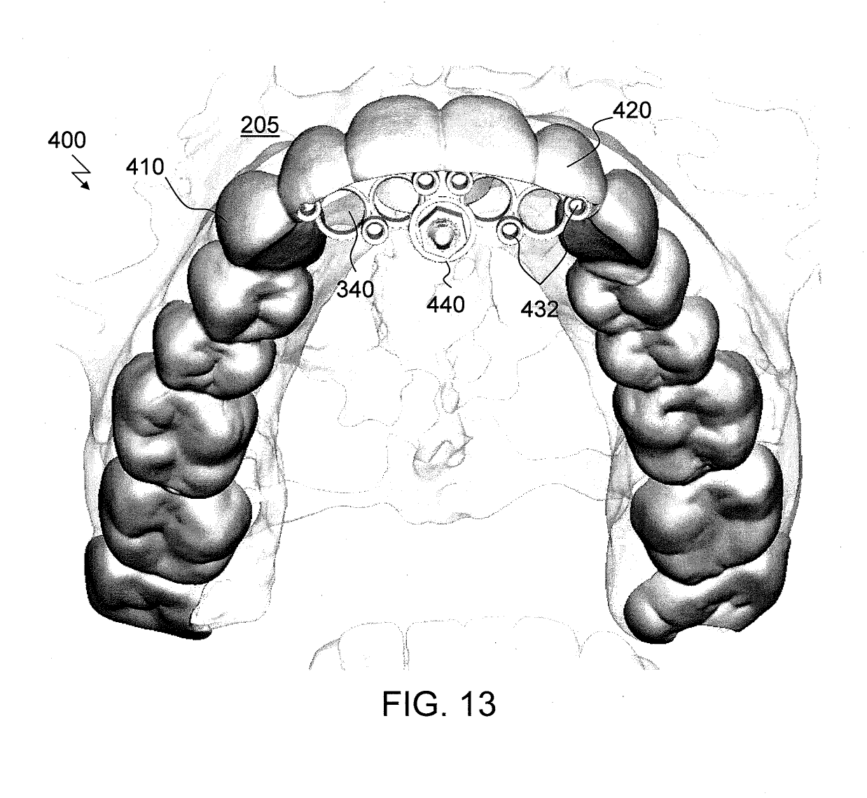

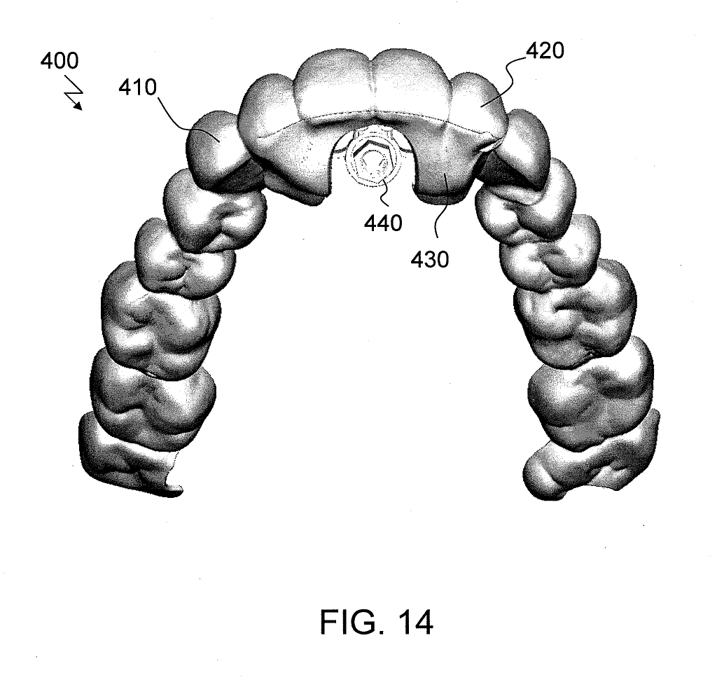

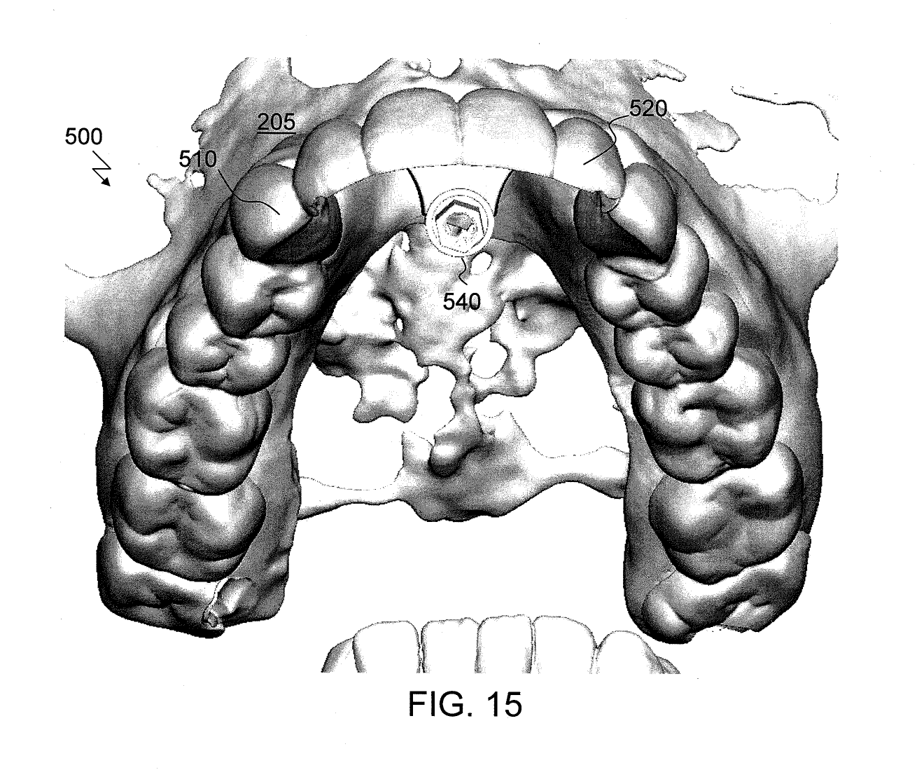

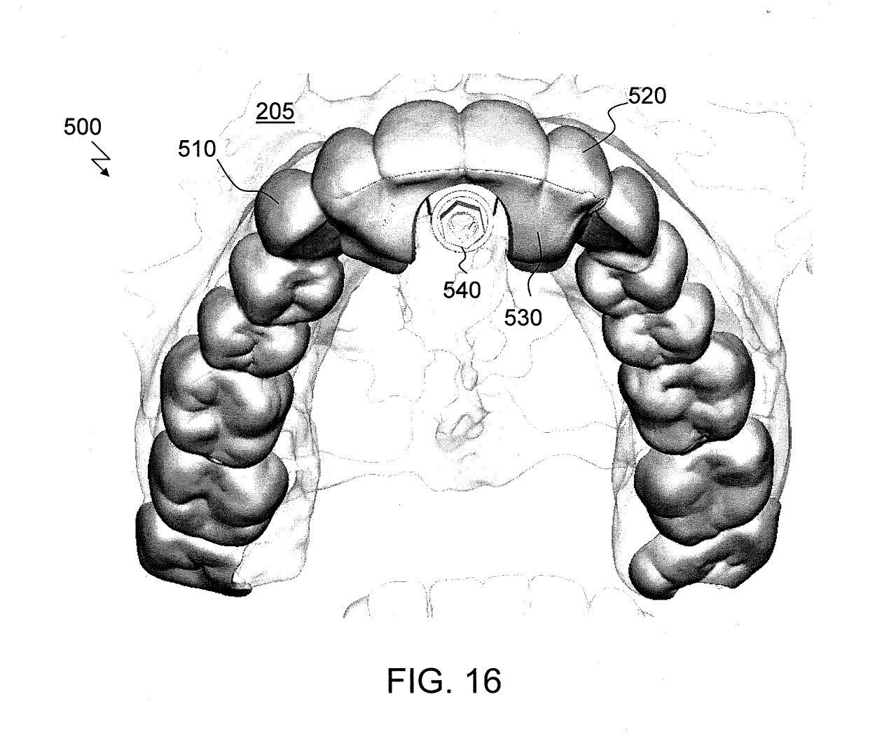

FIG. 13 shows a front and bottom perspective view of a transport prosthesis 400 according to an embodiment in which the transport prosthesis 400 only includes a single device support 440. The transport prosthesis 400 also includes a number of prosthetic guide teeth 420, caps 410, guide holes 432, and main apertures 340. FIG. 14 shows the transport prosthesis 400 of FIG. 13, further including a cover 430. FIG. 15 shows a front and bottom perspective view of a transport prosthesis 400 according to an embodiment in which the transport prosthesis 500 only includes a single device support 540 and does not include any guide holes. The transport prosthesis 500 includes a number of prosthetic guide teeth 520 and caps 510. FIG. 16 shows the transport prosthesis 500 of FIG. 15, further including a cover 530.

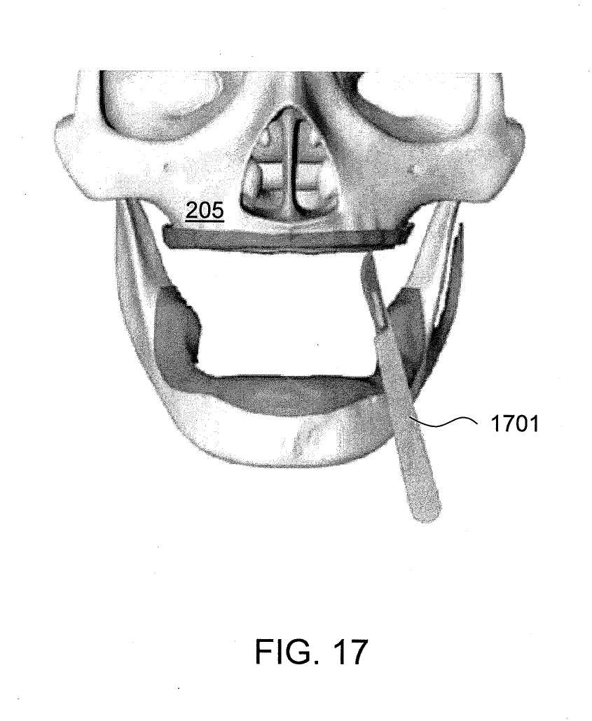

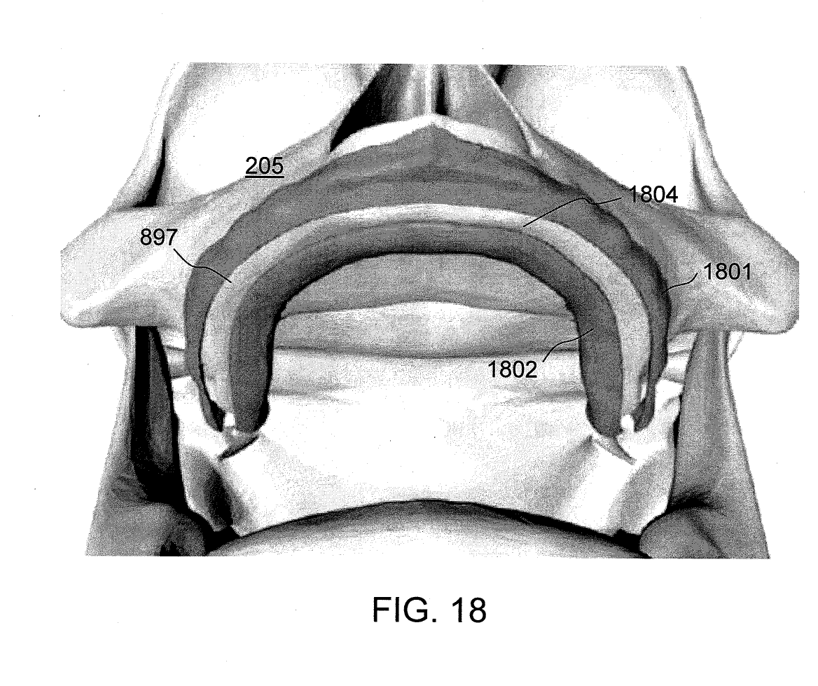

An exemplary method of installing the transport prosthesis at a predetermined site or area 897 (FIG. 18) where additional bone is required is described below. Prior to any surgical technique, proper treatment planning should be performed, including a physical examination, X-ray studies and consultation. Once the patient has been conventionally prepared for surgery, a local anesthetic is given and infiltrated into the surgical site. After allowing adequate time for anesthesia and vasoconstriction, a practitioner makes a crestal incision in the area of the defect using a scalpel 1701 or other instrument, as shown in FIG. 17, so that the full thickness buccal and lingual mucoperiosteal flaps 1801, 1802 are revealed, as shown in FIG. 18. The underlying bone of the alveolar ridge 1804 is conventionally exposed by, for example, raising the full thickness mucoperiosteal flaps with an elevator (not shown). The exposed bone 1804 may be conventionally evaluated by palpitation for bone density and quality.

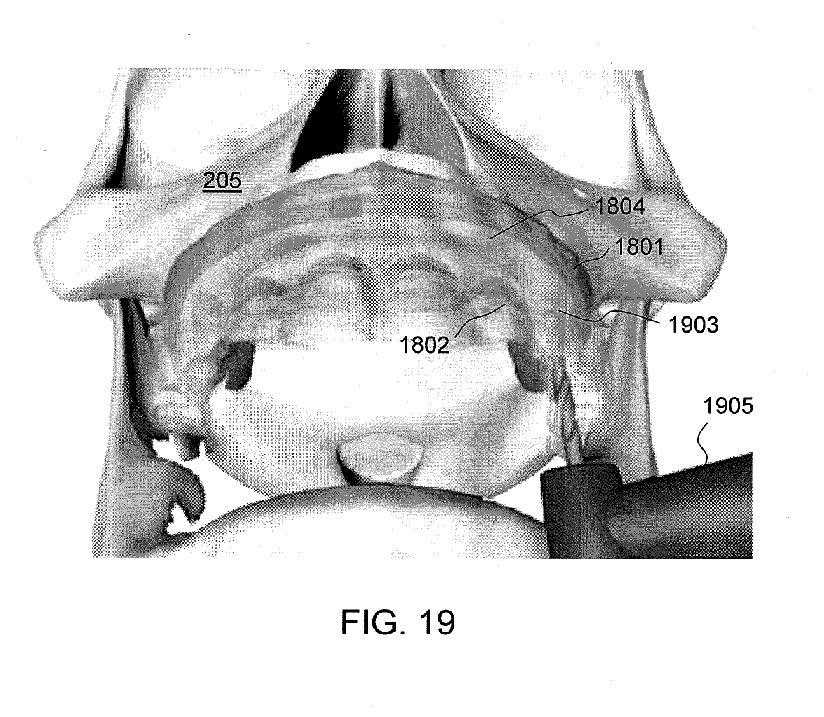

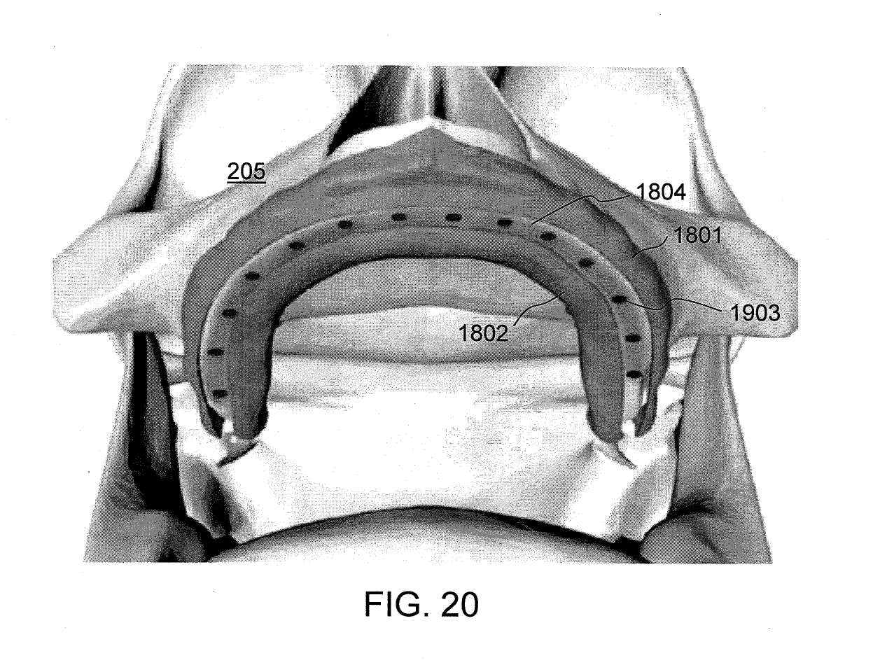

In one embodiment, the plate component 210 may be installed after the site 897 has suffered fresh trauma, such as where the tooth has been knocked out due to an accident or extracted from its bony socket. In another embodiment, the site 897 may be fully healed before the procedure to insert the plate component 210 is performed. Where the site is fully healed, one or more osteotomy cites 1903 may be created in the alveolar ridge 1804, using a drill 1905 or other instrument, to create controlled micro-surgical trauma of the bone, as shown in FIG. 19. It should be noted that other conventional procedures could be used to create the osteotomy. All of the bone drilling procedures include copious amounts of irrigation, (internally and/or externally). The osteotomy site is enlarged by utilizing progressively wider drills. Optionally, the parallelism of the osteotomy site can be verified by X-rays and/or paralleling pins. The final sized osteotomy site is completed by either utilizing the final, smooth, twist drill or by tapping in the threads corresponding to the combination distraction dental implant. FIG. 20 shows a number of osteotomy cites 1903 formed in the alveolar ridge 1804.

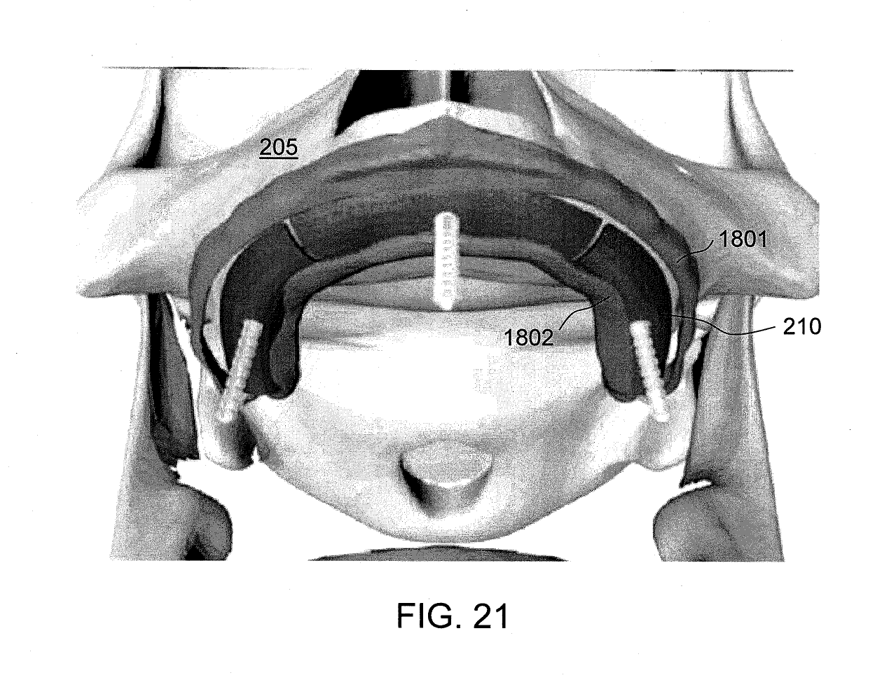

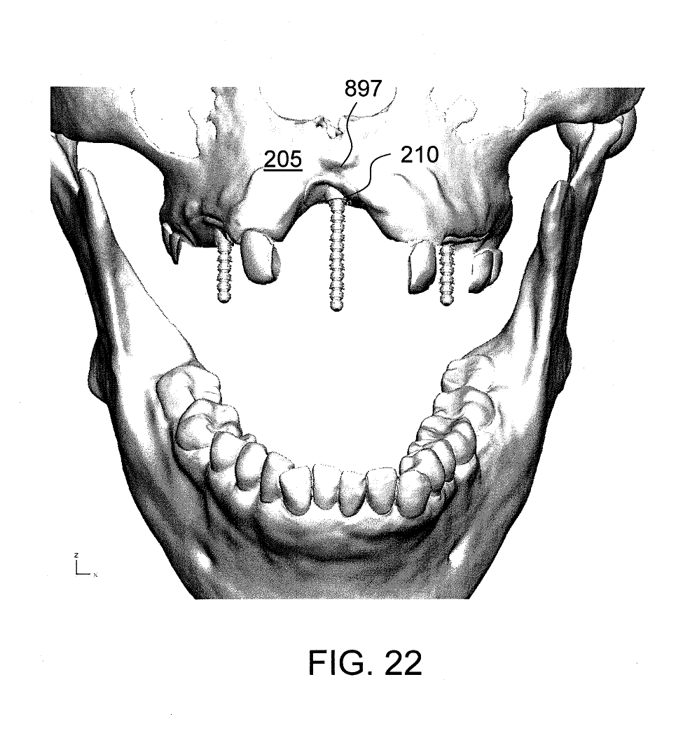

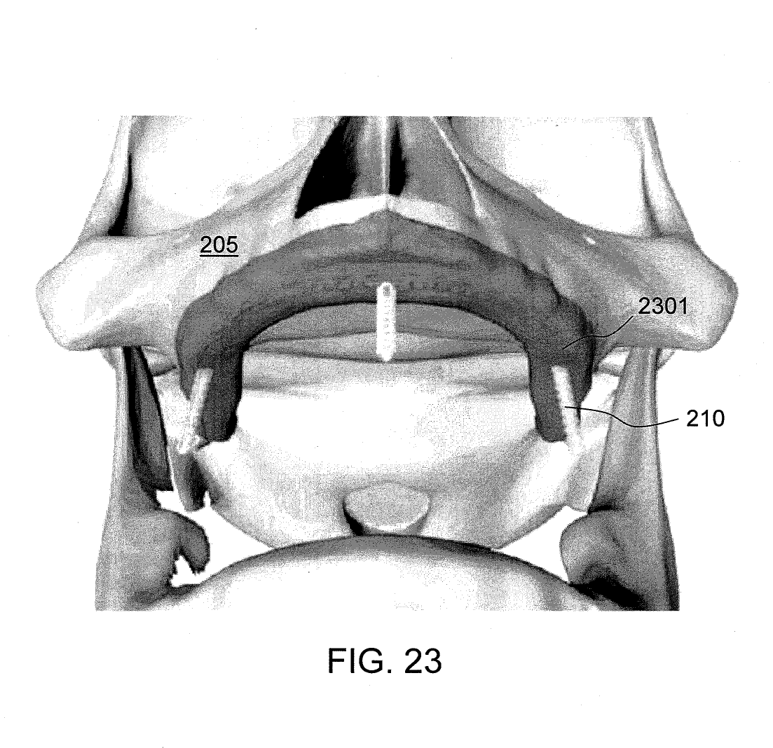

As shown in FIG. 21, the plate component 210 of the distraction device 200 is placed atop the osteotomy cites 1903 along the alveolar ridge 1904 where additional bone is required. FIG. 22 shows an example of the plate component 210 arranged at a various sites 897 requiring bone growth in a partially edentulous patent. As shown in FIG. 23, primary wound closure may be effected using traditional surgical techniques, for example by sutures 2301. In another embodiment, the plate component 210 may be omitted and the lifting of the tissue away from the osteotomy cites may be effected by the use of hydraulic, pneumatic, or mechanical means. For example, the tissue may be lifted away from the osteotomy cites by injecting fluid or air into a space between the osteotomy cites and the tissue.

The plate 211 of the plate component 210 may be shaped to fit the predetermined site 897 prior to the surgery. As described above, in one embodiment, the plate 211 may be shaped off-site or may be cut and/or shaped by the dentist on-site. The plate component 210 is placed onto or into the bone 205 manually or by use of a conventional implant drill set at slow speeds, as is known by those skilled in the art. The wound is irrigated and, if osteotomies are formed, the incisions are conventionally closed with the threaded cylinder 212 being exposed. Intimacy of the plate component 210 into the bone is verified visually and tactilely.

In one embodiment, in order to enhance the bone healing process during this procedure, bone growth factors such as bone morphogenetic proteins (BMPs) and basic fibroblast growth factor (bFGF) may be introduced to the area of distraction. These two classes of bone growth factors have been shown to accelerate bone regeneration, bone healing to prosthetic-like implants, and increase strength and stability to the bony callus. The bone growth factors could be delivered to the area of distraction by a variety of methods. One method would be to introduce the bone growth factors in combination with a collagen matrix, which could be a gel- or sponge-like material, to the area of distraction. The bone growth factor would stimulate the patient's own bone cells into action, while the collagen would provide the scaffolding into which the stimulated bone cells can grow. In the end, bone could replace the collagen scaffold, which may be eventually resorbed. Fibrinogen, a-thrombin, as well as other various antibiotics, growth hormones, gene therapies, or combinations of these factors may also be utilized in the distraction device 200 to promote healthy bone growth. The BMP material may be infused as a liquid or viscous gel substance. These cell therapies can be introduced to the bone site through a hollow transport pin.

Another method of delivery could be to coat the actual distraction device 200 with the bone growth factor in combination with a bioceramic, such as hydroxyapatite or betatricalciumphosphate, which would have a synergic stimulative effect on the bone cells. For this to be accomplished, a specific amount of the bone growth factor would be absorbed to a gritblasted hydroxyapatite coated implant or distraction device prior to implantation.

The transport prosthesis 300 may be formed prior to the surgery to closely conform to the patient's jaw and remaining teeth. A practitioner may capture data including images of the patient's jaw and/or remaining teeth by the use of a digital photograph, a conventional or cone-beam CT scan, a dental impression, a digital impression, or a combination thereof. The data may be imported to a data reader, for example, a DICOM medical data reader. Software may be used to design the transport prosthesis 300 to be used as part of a treatment plan that includes aesthetic consideration and tissue regeneration. The software may use various forms of complex analysis, including cephalometric analysis, to create a design for the transport prosthesis 300 that ensures ideal implant, abutment, and crown placement and to allow for advance planning of bone growth along a controlled vector. The various portions of the transport prosthesis may then be fabricated from the design using methods such as advanced direct digital manufacturing, CNC machining, robotics, and/or other various manufacturing steps commonly used to produce conventional dentures. The completed transport prosthesis may then be provided to the dental practitioner by itself, or as part of a kit that may include the transport prosthesis, a tool for adjusting the expansion component, such as those described in U.S. patent application Ser. No. 12/619,563, dental implants, and/or abutments and crowns.

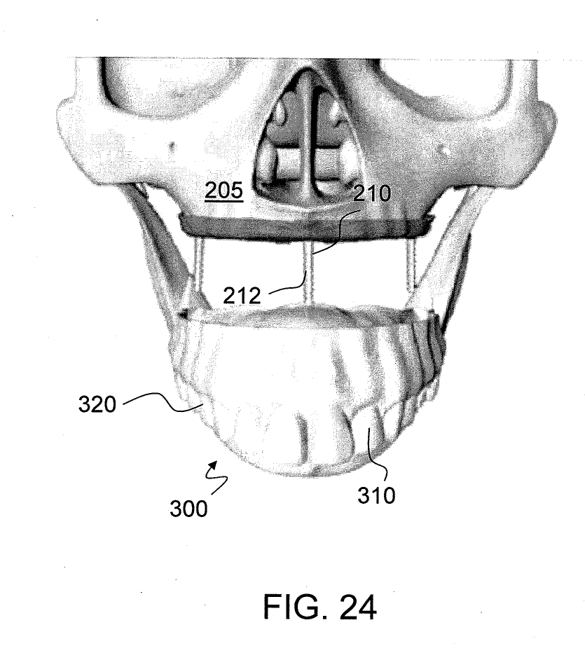

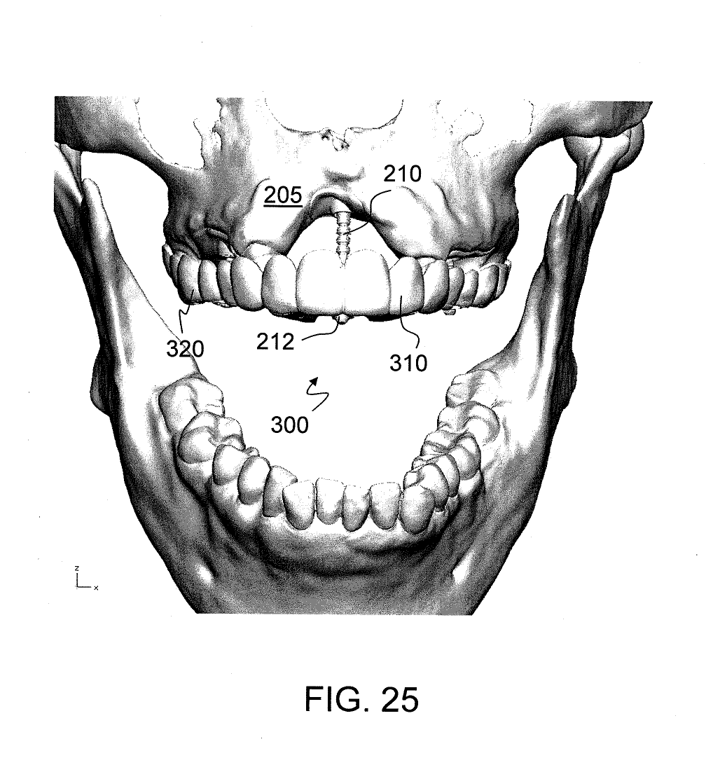

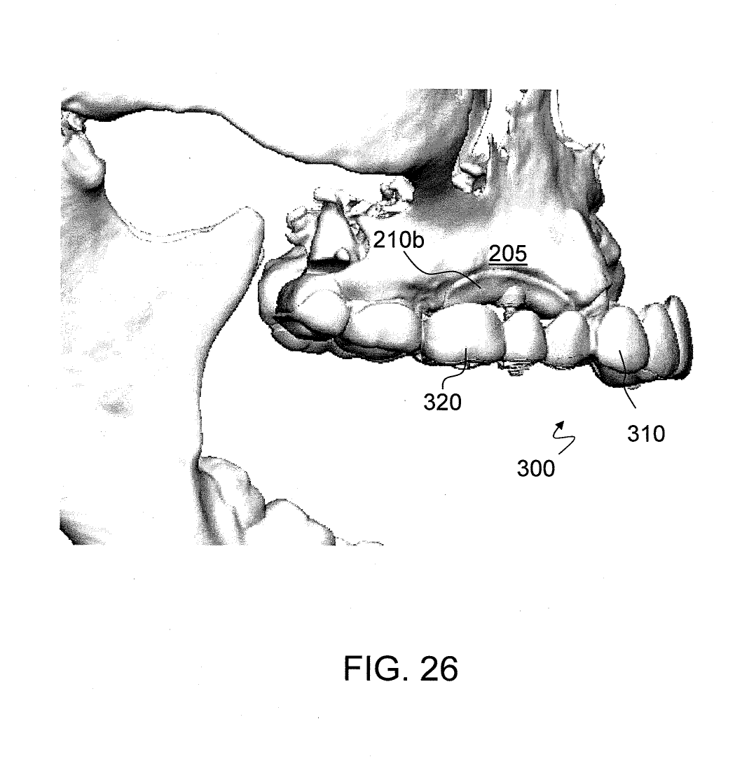

FIG. 24 is a view of a fully edentulous patient in the process of being fitted with the transport prosthesis 300. FIG. 25 is a front view and FIG. 26 is a side view of a partially edentulous patient fitted with the transport prosthesis 300. As shown in FIGS. 24, 25, and 26, the transport prosthesis 300 is arranged over the plate component 210 of the distraction device 200 so that the threaded cylinder 212 extends through the support housing 340 (FIG. 10). Where the patient is partially edentulous, the transport prosthesis 300 may be attached to the patient's remaining teeth by snapping on, any adhesive method known in the art, screws, or a combination thereof. If a patient is completely edentulous, the transport prosthesis 300 may be attached directly to the bone, for example, by dental fixation screws.

The expansion component 220 may then be attached to the plate component 210. The expansion component 220 must be rotatable around the plate component 210, as will be discussed in detail below. As mentioned above, expansion component 220 has internal threads that can operatively engage with external threads of plate component 210 of the distraction device 200 during implantation. The expansion component 220 is rotated and thus must not be fixedly connected to the plate component 210 in such a way as to prevent the expansion component 220 from freely rotating around the plate component 210 as the plate component 210 rotationally raises from the patient's bone as the gap between the plate and expansion components 210, 220 is decreased axially during implantation by the interaction of the internal threads of the expansion component 220 with the external threads of the plate component 210. Other conventional means for maintaining the rotatability of the expansion component 220 would be acceptable.

The plate component 210 remains stationary in the bone and rotational movement of the expansion component 220, provided by, such as for example, the interaction of the threads of the expansion component 220 with the external threads of the plate component 210, provide for the retraction of the plate component 210 to the expansion component 220. The body then attempts to heal itself by filling in the gap with new bone. If the gap is widened daily, the body recognizes the newly expanded gap and continues to fill the gap with new bone. By expanding the gap slowly over time (0.5-2.0 millimeters per day), the body will continue to heal the gap and generate new bone. Consequently, because the native bone is utilized as the template for repair, the new bone generated will comprise the same size, shape, density, and other characteristics as the original bone. Such results are advantageous and unique to new bone generation and are not accomplished when using other conventional bone transplantation techniques. Furthermore, during distraction osteogenesis, in addition to creating new bone, the overlying soft tissues are regenerated, a secondary gain unique to distraction osteogenesis. This secondary beneficial effect has significant clinical implications, for not only is the underlying foundation properly established, but also the overlying soft tissue is recreated providing for aesthetic and functional rehabilitation of the defect.

The top surface 280 of the expansion component 220 has a hexagonal shaped aperture 290. The aperture 290 provides the mechanical access to rotate the expansion component 220 to activate the distraction process via a corresponding hexagonal key. The hexagonal key may be made from stainless steel, and causes retraction of the plate and expansion components 210, 220 of the distraction device 200 during operation, as will be described more fully below.

The patient is then educated as to the care and activation of the distraction device 200. After allowing for a period of initial healing, a latency period (of about 5-7 days), the expansion component 220 is activated or maneuvered, (turned) thereby retracting the plate component 210 to the expansion component 220 (about 1.0 mm per day) in divided doses, and thus creating a distraction gap above the bone. The patient is also educated to make the adjustment necessary to increase or widen the gap each day. Thereafter, the patient is seen for follow-up and evaluation as appropriate. Since the typical height of a natural tooth crown above the gum is about eight (8) mm, in order to properly function, the distal end of the expansion component 220 should not extend above the level of the lowest adjacent tooth crown.

After sufficient bone height (about 5 mm to about 15 mm) is achieved, the distraction process is halted. In one embodiment, the transport prosthesis 300 and expansion component 220 are removed. In another embodiment, the transport prosthesis is left in place and a drill is aligned with the main aperture 330 of a guide tooth using the guide holes 332. The drill is used to form a hole in the newly grown bone to affix a more permanent prosthetic tooth. In one embodiment, because the newly grown bone may be relatively weak and incompletely ossified, a period of about four to about six weeks is required before the installation of the final prosthesis.

The foregoing description illustrated one specific application of the technique and technology of distraction osteogenesis to the field of dental implants using an exemplary transport prosthesis, distraction device, and method. Since conventional dental implants have similar basic forms, it should be apparent to those skilled in the art that the potential combinations and rearrangements of the various features of the transport prosthesis and distraction device are unlimited.

Advantages of embodiments described herein include providing new bone growth and soft tissue formation, thereby, reducing the number and morbidity of surgical procedures a patient is subjected to during the distraction as compared to the prior surgical procedures. Additionally, the transport prosthesis and distraction device described above provides for increased versatility by using an expansion component 220 to continuously adjust the distraction gap during the bone regeneration process without additional surgical procedures. The embodiments of the transport prosthetic and distraction device are also more aesthetically pleasing during the actual distraction process as compared to conventional devices and methods. It should also be appreciated to those skilled in the art that the above concept of a transport prosthetic and distraction device is not limited to use as a dental implant and could be used as a general distraction device in the maxillofacial region.

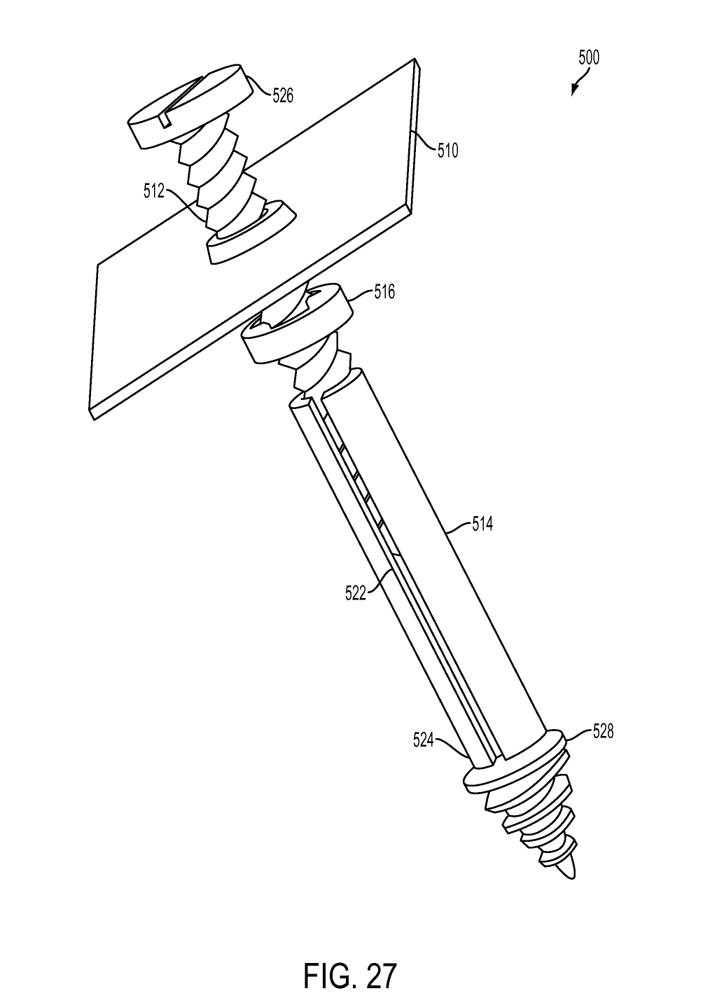

FIG. 27 shows another embodiment of a transport prosthesis 500. The transport prosthesis 500 includes a plate 510 having a hole 512. The hole 112 is arranged to slide over a sheath housing 514. The plate 510 is raised along the sheath housing by a transport ring 516. The plate 510 can be metallic, ceramic, or a polymer. Furthermore, the plate 510 can be biodegradable and may be solid or perforated.

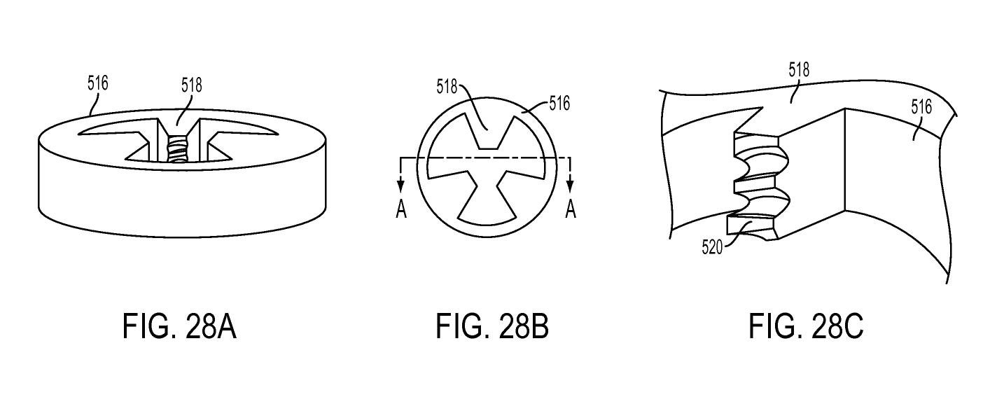

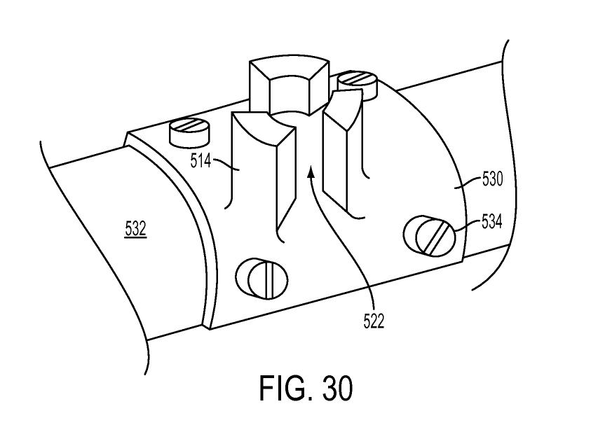

FIG. 28A shows a perspective view of the transport ring 516 and FIG. 28B shows a top view of the transport ring 516. FIG. 28C shows a cut-away view of the transport ring 516 taken along line AA, as shown in FIG. 28B. The transport ring 516 includes three arms 518. The arms 518 have internal threads 520 arranged on their ends. The transport ring arms 518 are designed to follow along the slots 522 to the base 524 of the sheath housing 514. The sheath housing 514 allows for transport of the distraction plate 510 and transport ring 516. The sheath housing 514 also holds the activation screw 526. The sheath housing 514 consists of a hollow tube with three slots 522 of equal size along its length at 120 degree intervals. At the base 524 of the sheath housing 514 can be either a drill 528, as shown in FIG. 27, or a saddle 530, as shown in FIG. 30, for fixation into the bone.

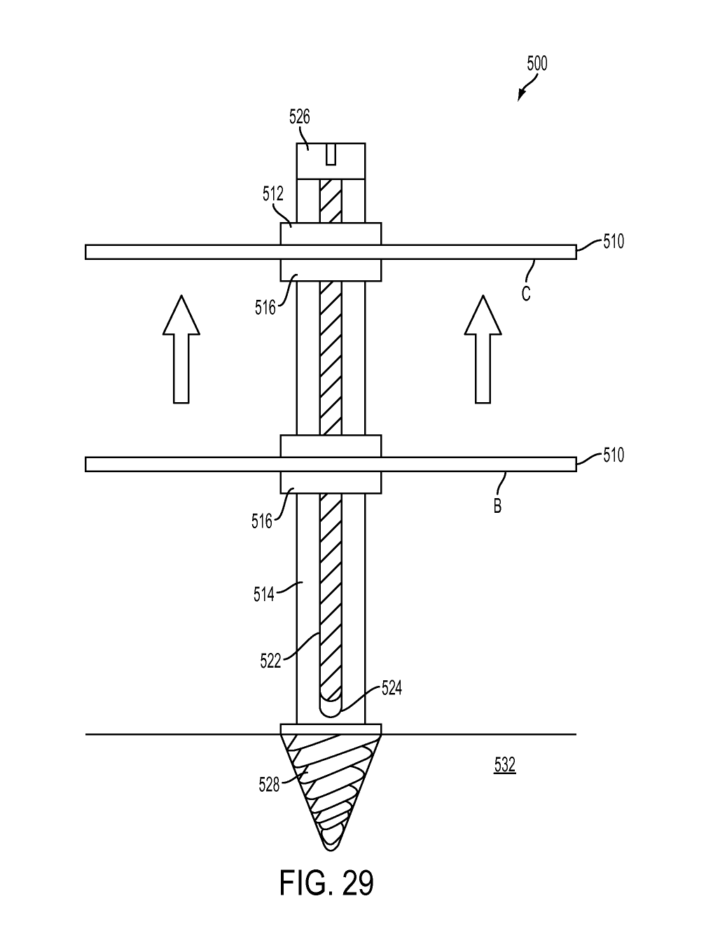

The activation screw 526 allows for movement of the transport ring 516. The activation screw 526 sets within the sheath housing 514. To operate, the sheath housing 514 is fixed into the bone 532 (FIG. 29), either by the drill 528 or saddle 530. The drill 528 may be drilled into the bone 532 to fix the sheath housing 514. As shown in FIG. 30, the saddle 530 may be attached to the bone 532 by a number of screws 534. The transport ring 516 is slid along the sheath housing 514 to its base 524. The plate 510 is set along the sheath housing 514 to the base 524 as well. The activation screw 526 is screwed into the sheath housing 514. As shown in FIG. 29, once the activation screw 526 has reached the base 524 of the sheath housing 514, the transport ring 516 will rise and push the distraction plate 510 along with it, for example, from point B to point C of FIG. 29.

Changes and modifications in the specifically described embodiments and methods can be carried out without departing from the scope of the invention which is intended to be limited only by the scope of the appended claims.

What is claimed as new and desired to be protected by Letters Patent of the United States is:

1. A dental prosthesis comprising:
a prosthetic tooth having a main aperture arranged therein to allow access from the top of the prosthetic tooth through the bottom of the prosthetic tooth; and
a cover configured to be coupled to the top of the prosthetic tooth over the main aperture.

2. The dental prosthesis of claim 1, wherein the prosthetic tooth is shaped as a lower portion of a tooth and the cover is shaped as an uppermost portion of a tooth.

3. The dental prosthesis of claim 1, wherein the cover includes a through hole.

4. The dental prosthesis of claim 1, wherein the cover includes a device support having a through hole and configured to support a distraction device for growing new bone in an area of deficient bone.

5. The dental prosthesis of claim 1, further comprising a plurality of prosthetic teeth, each having a main aperture arranged therein to allow access from the top of each of the prosthetic tooth through the bottom of each prosthetic tooth; and
a plurality of covers, each configured to be coupled to the top of one of the prosthetic teeth over their respective main apertures.

6. The dental prosthesis of claim 1, further comprising a cap shaped to fit over a tooth of a patient.

7. The dental prosthesis of claim 1, further comprising a prosthetic tooth veneer and a first hoop attached to the prosthetic tooth veneer.

8. The dental prosthesis of claim 7, further comprising a device support configured to support a distraction device for growing new bone in an area of deficient bone, the device support being attached to the hoop.

9. The dental prosthesis of claim. 7, further comprising a plurality of smaller second hoops connected to the first hoop.

10. The dental prosthesis of claim 1, wherein the prosthetic tooth includes a plurality of guide holes arranged around the main aperture.

11. The dental prosthesis of claim 1, further comprising a distraction device, the distraction device comprising:
a plate component for growing new bone in an area of deficient bone; and
an expansion component for operatively connecting and controllably retracting the plate component.

12. The dental prosthesis of claim 11, wherein said plate component includes a plate and a threaded cylinder extending from the plate.

13. The dental prosthesis of claim 11, wherein said expansion component comprises a hollow slot for retracting the plate component.

14. The dental prosthesis of claim 11, wherein the expansion component is rotatable around said plate component.

15. A method of bone regeneration comprising:
arranging a plate against a surface of a bone of a patient, the plate having a stem extending therefrom;
arranging a dental prosthesis over the plate component, wherein the stem extends through an aperture in the dental prosthesis; and
attaching an expansion component to the stem such that the expansion component may be operated to move the plate away from the surface of the bone.

16. The method of claim 15, further comprising adjusting the expansion component to retract the plate from the surface of the bone to create a gap between the plate and the surface of the bone.

17. The method of claim 16, wherein the stem is a threaded cylinder and wherein the expansion component may be rotated to move the plate way from the surface of the bone.

18. The method of claim 15, further comprising forming a series of aerated holes within the surface of the bone before arranging the plate against the surface of the bone.

19. The method of claim 15, further comprising shaping the plate to conform to the surface of the bone before arranging the plate against the surface of the bone.

20. The method of claim 15, further comprising coating the plate with bone growth factor.

21. The method of claim 15, further comprising attaching the dental prosthesis to the patent's remaining teeth using adhesive.

22. The method of claim 15, further comprising attaching the dental prosthesis to the patent's remaining teeth using screws.

23. The method of claim 15, further comprising attaching the dental prosthesis to the patent's jaw bone using screws.

24. The method of claim 15, wherein the expansion component is supported by the dental prosthesis.

25. The method of claim 15, wherein the plate is moved away from the surface of the bone about 0.5 to 2.0 millimeters per day.

26. The method of claim 15, further comprising aligning a drill over the bone using guide holes arranged in the dental prosthesis.

27. The method of claim 26, further comprising forming a hole in the bone and inserting a prosthesis into the hole.

28. The method of claim 15, wherein said method is used intraorally.

29. A distraction device comprising:
a plate component for growing new bone in an area of deficient bone, the plate component comprising a plate shaped to conform to the area of deficient bone; and
an expansion component for operatively connecting and controllably retracting the plate component.

30. The distraction device of claim 29, wherein said plate component further comprises a stem extending vertically from the plate.

31. The distraction device of claim 30, wherein the stem is a threaded cylinder.

32. The distraction device of claim 29, wherein said expansion component is operated hydraulically.

33. The distraction device of claim 29, wherein said expansion component is operated pneumatically.

34. The distraction device of claim 29, wherein said expansion component comprises a hollow slot for retracting the plate component.

35. The distraction device of claim 34, wherein said hollow slot has a cylindrical configuration and comprises internal threads.

36. The distraction device of claim 29, wherein said plate comprises hydroxyapatite material.

37. The distraction device of claim 29, wherein said plate comprises a bioceramic material.

38. The distraction device of claim 29, wherein said plate comprises a melt-blended polymer composition comprising: a base material including a biodegradable polymer or copolymer, and a copolymer additive including one or more monomers imparting a tensile strength for the implant at room temperature that is lower than a tensile strength at room temperature for an implant formed from the base material excluding the copolymer additive.

39. The distraction device of claim 29, wherein said plate comprises a melt-blended polymer composition comprising: a base material including a biodegradable polymer or copolymer, and a copolymer additive including one or more monomers imparting a tensile strength for the melt-blended polymer composition at room temperature that is lower than a tensile strength at room temperature for the base material.

40. The distraction device of claim 29, wherein the expansion component is rotatable around said plate component.

41. The distraction device of claim 1 further comprising an abutment for attaching a prostheses.

42. The distraction device of claim 29, wherein said plate and expansion components are used intraorally.

43. A method of bone regeneration comprising:
conforming a plate of a plate component to an area of deficient bone;
arranging the plate adjacent to a surface of the area of deficient bone;
attaching an expansion component to the plate component; and
retracting the plate component from the surface of the area of deficient bone using the expansion component to create a gap between the plate and the surface of the area of deficient bone to promote bone growth.

44. The method of claim 43, further comprising removing said expansion component after sufficient bone growth has occurred.

45. The method of claim 44, further comprising drilling a hole into the bone growth and installing a prosthesis.

46. The method of claim 43, wherein said method is used intraorally.

47. The method of claim 43, further comprising attaching the expansion component to a stem extending from the plate.

48. The method of claim 43, further comprising arranging a dental prosthesis over the plate component, and attaching the an expansion component to the plate component such that the dental prosthesis supports the expansion component.

49. The method of claim 43, further comprising forming a series of aerated holes within the surface of the area of deficient bone before arranging the plate against the surface of the area of the deficient bone.

50. The method of claim 43, further comprising coating the plate with bone growth factor.

51. The method of claim 43, wherein the plate is moved away from the area of deficient bone by about 0.5 to 2.0 millimeters per day.

52. The method of claim 43, further comprising retracting the plate component using hydraulic pressure.

53. The method of claim 43, further comprising retracting the plate component using pneumatic pressure.

54. A method of bone regeneration comprising:
forming an osteotomy cite in an area of bone to be regenerated;
retracting tissue overlying the osteotomy cite to create a space between the osteotomy cite and the tissue; and
allowing bone to grow into the space between the osteotomy cite and the tissue.

55. The method of claim 54, wherein forming an osteotomy cite comprising forming a series of aerated holes within the surface of the area of bone to be regenerated.

56. The method of claim 54, wherein the osteotomy cite is formed by trauma.

57. The method of claim 54, further comprising arranging a plate adjacent to the osteotomy cite, wherein the tissue is retracted from the osteotomy cite by adjusting the location of the plate.

58. The method of claim 54, wherein the tissue is retracted from the osteotomy cite by injecting a fluid between the tissue and the osteotomy cite.

59. The method of claim 54, wherein the tissue is retracted from the osteotomy cite by injecting air between the tissue and the osteotomy cite.

60. The method of claim 54, wherein the tissue is retracted from the osteotomy cite by about 0.5 to 2.0 millimeters per day.
